(19) United States
(12) Patent Application Publication
(10) Pub. No.: US 2022/0334829 A1
(43) Pub. Date: Oct. 20, 2022

(54) CUSTOM ABAP CLOUD ENABLER

(71) Applicant: SAP SE, Walldorf (DE)

(72) Inventors: Garima Srivastava, Bangalore (IN); Swarnava Chatterjee, Bangalore (IN)

(21) Appl. No.: 17/231,222

(22) Filed: Apr. 15, 2021

(51) Int. Cl. G06F 8/71; G06F 8/41; G06F 8/20; G06F 11/32; G06F 11/30

(52) U.S. Cl. CPC G06F 8/71; G06F 8/443; G06F 8/20; G06F 11/323; G06F 11/3082

(57) ABSTRACT

According to some embodiments, a system and methods comprising receiving application code for an on-premise application at a custom code cloud enabler module, wherein the application code includes at least one package of a plurality of objects; providing a whitelist of a plurality of cloud elements for the plurality of objects; identifying a first enhancement point in a first application object of the plurality of objects, the first enhancement point including a first extension element; selecting a first cloud element from the whitelist of cloud elements; determining the selected first cloud element matches a structure definition of the first extension element; mapping one or more parameters of the first extension element to one or more parameters in the matched first cloud element generating a cloud code snippet for the first extension element based on the mapping; and executing the generated cloud code snippet for the first enhancement point as part of the cloud code on a cloud platform. Numerous other aspects are provided.

### BACKGROUND

Conventionally, organizations make use of on-premise software, which is installed and runs on computers or servers on the premises of the organization using the software, rather than at a remote facility such as a server farm or cloud. With on-premise software, the software is downloaded or installed directly on the computers or servers that will be executing the software. An organization may commonly take a standard vanilla application from an application provider and enhance the application with custom extension/add-on code (“extension/add-ons”) to tailor the application to the organization's needs. The organization may make a significant investment with the creation and operation of these extensions/add-ons, as they may include hundreds of lines of code and may need to be written in a particular format and/or language to be operable with the vanilla application upon execution thereof.

In recent history there has been an effort for organizations to move their computing to cloud platforms, using a Software as a Service (SaaS) model in which software is licensed on a subscription basis and is centrally hosted. SaaS is also known as cloud-based software. When an organization wants to move their existing on-premise software to a cloud platform, the extensions/add-ons may not be directly transferrable. For example, different software may be used in the cloud versus on-premise, applications and data which the on-premise application uses may not be available on the cloud, the development paradigm used to create extensions/add-ons on on-premise might be very different on cloud etc.

Systems and methods are desired which support an intelligent migration of on-premise applications having custom extensions/add-ons to a cloud platform.

### BRIEF DESCRIPTION OF THE DRAWINGS

FIG. 1 is a block diagram of a system architecture according to some embodiments.

FIG. 2 is a flow diagram according to some embodiments.

FIG. 3 is a package according to some embodiments.

FIG. 4 is a non-exhaustive example according to some embodiments.

FIG. 5A is a non-exhaustive example according to some embodiments.

FIG. 5B is a non-exhaustive example according to some embodiments.

FIG. 6 is a continuation of the non-exhaustive example of FIG. 4 according to some embodiments.

FIG. 7 is a continuation of the non-exhaustive example of FIG. 4 according to some embodiments.

FIG. 8 is a flow diagram according to some embodiments.

FIG. 9 is a block diagram of a system according to some embodiments.

FIG. 10 is a user interface according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

One or more embodiments or elements thereof can be implemented in the form of a computer program product including a non-transitory computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

As described above, an organization may modify a standard software application via custom extension code to tailor the application to the organization's needs. As used herein, the terms “add-ons” and “extensions” may be used interchangeably, and may refer to a computer code snippet.

As a non-exhaustive example, take various countries and organizations in the oil & gas, chemical or mining industries, that may work with hydrocarbon products. Hydrocarbon products generally expand or compress with variation of temperature, pressure, density, etc. and it is desirable for these industries to perform their business according to standards governed in their country or according to standards defined globally. For example, diesel loaded in a container in Germany at L15 (Liters at 15 degrees Celsius) may be unloaded in France at L30 (Liters at 30 degrees Celsius), or unloaded at a non-standard conversion of BBL (Billion Barrels). When such products are moved from one place to another, volumes differ and hence cost calculation may occur at the unit being used at the destination, which may vary from the unit at the source. So, for organizations dealing with hydrocarbon products, considering these factors to calculate exact volume may be very important. Across the globe, there are several regulators (e.g., American Petroleum Institute (API)) who have already defined these conversion standards, while some industries have defined their own conversion routines.

These organizations may use a standard software application for tracking the products. However, as performing the conversion of the hydrocarbon product (on the basis of temperature, pressure, etc.) may be legally binding and requires an in-depth knowledge of the domain, the organization may want to tailor the standard software application to execute the conversion. To that end, the organization may build an extension for the standard software application to perform this conversion.

The creation of these extensions requires an investment of time and finances, when an organization moves their computing to a cloud platform, it would be desirable to enable their existing extensions on the cloud platform. However, conventionally, the language used to write the extension may be different from the language supported by the cloud platform (e.g., JAVA, Node.js, etc.), and/or the cloud platform which may not support files, etc. used by the on-premise application/extensions.

Conventionally, tools exist to aid in the migration, or movement, of an on-premise software application (including extensions) to a cloud platform. ABAP Test Cockpit (ATC), provided by SAP, which is the assignee hereof, is a non-exhaustive example of such a tool that may be used to aid migration by identifying some issues that exist once the code for the extension (“extension code”) is imported onto the cloud platform. For example, ATC may incorporate some static and simple rule-based checks, so that the ATC may identify errors in the extension code (e.g., elements in the extension code that need to be changed/are not working). Examples of static checks include, but are not limited to, use of development objects, which are not supported (e.g., Dynpros, Reports . . . ) use of development objects that are not released. The ATC may, in some instances, provide automatic code adaptations for the errors identified by the static checks. The inventors realize that it would be better if the migration aid tools were able to identify errors with the migrated code (i.e., the extension code cannot execute) that are beyond those identified by static checks. For example, many contextual errors and adjustments cannot be considered in a static rule-based tool. Non-exhaustive examples of these contextual errors/adjustments are adjustments to the enhancement implementation; finding Application Programming Interfaces (APIs) suitable to remove direct function calls; finding suitable cloud-based BADIs, which may need to replace existing obsolete BADIs; and generating contextual cloud based implementations for the extension code.

Embodiments provide a custom code cloud enabler module (“CE module”) that identifies contextual extension code including but not limited to, implicit enhancement extensions, explicit enhancement extensions, and implementations of Business Add-Ins (BADI), that has not been enabled on a cloud platform (and may be considered an “error”) during migration of its associated on-premise application to the cloud platform. Once the CE module identifies the contextual extension code, the CE module may generate proposed adjustments for the contextual extension code to successfully execute on the cloud platform. The adjustments may include, but are not limited to the CE module's search for corresponding Cloud BADI/Whitelisted API that may be used with the contextual extension code so that the contextual extension code may execute on the cloud platform.

A BADI is a source code plug-in provided by SAP to enhance existing code. The enhancement uses an object-oriented method and the business add-ins is mapped to the specific requirements involved in business processes. A BADI must first be defined and then implemented to enhance the software application. While defining a BADI, an interface is created. BADI is implemented by this interface, which in turn is implemented by one or more adaptor classes. BADI is different from the implicit/explicit enhancements described further below in that a BADI may be: 1. provided by the application provider, as opposed to implicit/explicit enhancements provided by organization using the BADI and 2. used by many users simultaneously, while the implicit/explicit enhancements can be implemented only once.

In addition to identifying specific errors, the CE module may identify the number of issues/errors in the extension code once the code is migrated to the cloud platform. This identification may provide a collected view of the overall issues presented with the migration. In embodiments, the CE module may also classify the errors encountered in the migration of the extension code. The classification may be used for upskilling developers, or to gauge effort expenditures to address the errors. Regarding the upskilling, for example, consider a scenario where there were dynamic programming calls in the extension code made which now need to be converted to CDS (Core Data Services). Knowing how many such instances need to be corrected or re-implemented may help plan for CDS upskilling.

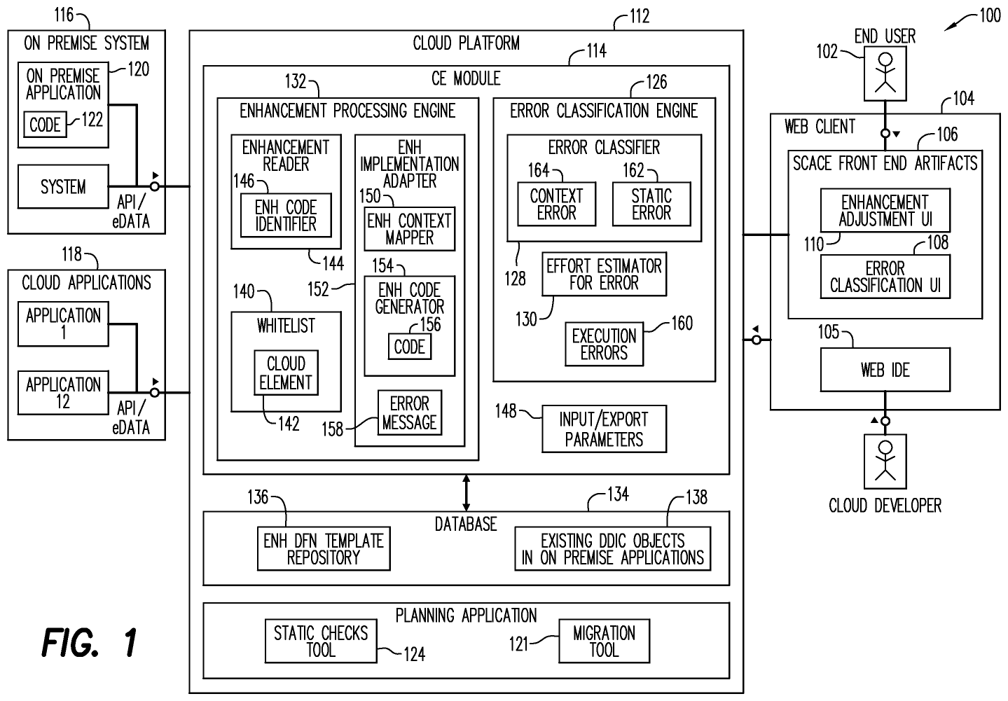

FIG. 1 is a block diagram of system architecture 100 according to some embodiments. Embodiments are not limited to architecture 100.

Architecture 100 includes a client/end user 102, a web client 104 including a Web Integrated Development Environment (IDE) editor 105, a front end artifacts 106 of an error classification user interface (UI) 108 and an enhancement adjustment user interface (UI) 110, a cloud platform 112, a custom code cloud enabler module (“CE module”) 114, an on premise system 116 and cloud applications 118.

It is noted that CE module 114 may be deployed in at least one of two manners. As a first deployment manner, the CE module 114 may be deployed as a SaaS offering so that it may be easily integrated with cloud-based applications and be consumed on an on-premise stack (e.g., Enterprise Resource Planning Systems installed on computers on the premises of an organization). With this deployment manner, the extension code may be adjusted by the CE module 114 once the extension code is installed on the cloud platform 112. As a second deployment manner (not shown), the CE module may be used as a built-in solution with the cloud platform 112, where whitelisted objects from the cloud platform 112 may be used to create/deploy the extensions. With the second deployment manner, the CE module 114 may be considered to be provisioned with the cloud platform, so that when the user installs his extension code on an embedded cloud code stack (in this case Cloud Platform ABAP Environment) the user may use this framework to adopt the extension. It is noted that the first deployment option may be preferrable in a case the user wants to prepare his add-on/extensions in the on-premise stack and the second option may be preferable in a case the user may be ready to completely install his software from on-premise hosting to the cloud platform.

In the example architecture 100 of FIG. 1, the architecture 100 may include a cloud platform 112. The cloud platform 112 provides any suitable interfaces through which clients (e.g., web client 104, end user 102 via web client 104, on-premise system 116 and cloud applications 118) may communicate with the CE module 114.

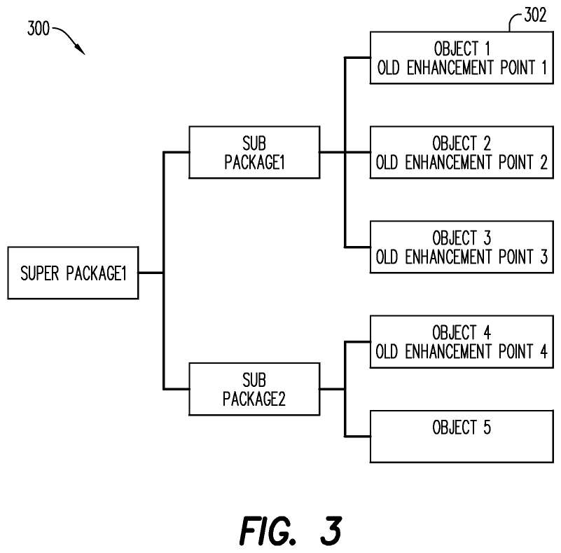

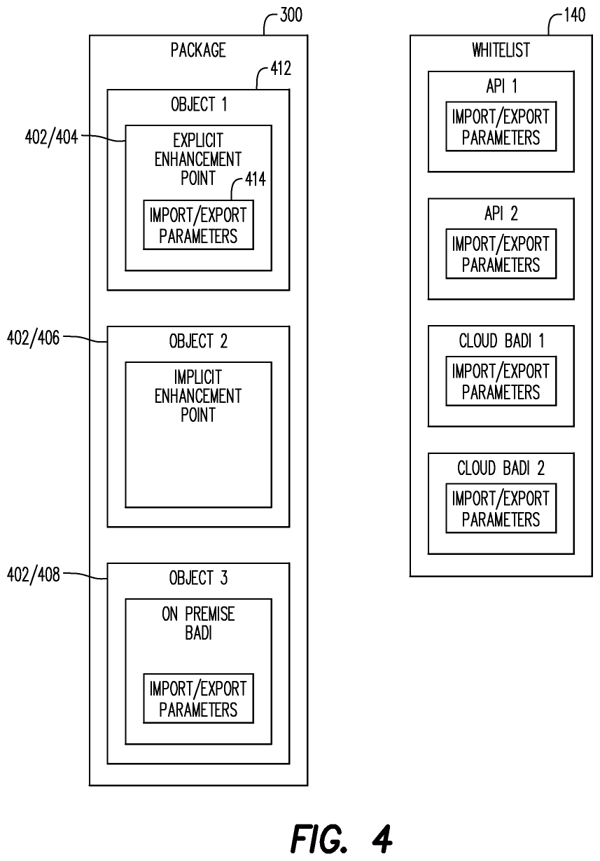

The on-premise system 116 may include at least one on-premise application 120. The on-premise application 120 may be migrated to the cloud platform 112, and may be made to execute on the cloud platform 112 via the CE module 114 and processes described herein. The on-premise application 120 may include application code 122 may also include at least one package 300 (FIG. 3). The package 300 may be an entity formed from a collection of one or more objects 302. The objects 302 may be a software artifact (e.g., a Class, or a Method in a class). It is noted that each package 300 may have a hierarchy of its own (e.g., packages within packages, etc.). As a non-exhaustive example, FIG. 3 illustrates a Super Package including two Sub Packages, where each Sub Package includes a plurality of Objects 302. For ease of explanation, the following description will be with respect to a single package including multiple objects as shown in FIGS. 4 and 6-7.

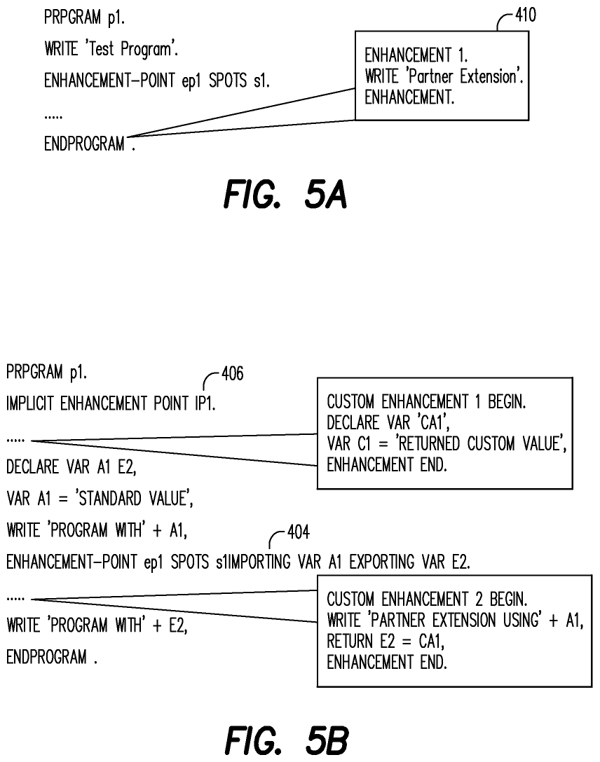

As described above, user's may create custom code to tailor the on-premise application to their needs. This custom code may be considered “contextual” and may be included in the on-premise application 120 at an enhancement point 402 in the object 302 as 1. An explicit enhancement 404, 2. An implicit enhancement 406, or 3. An on-premise application BADI 408. With respect to the explicit enhancement 404, the on-premise application 120 may include one or more enhancement points/hooks 402 in the code where a user may create their enhancements/add-on code 410. For example, FIGS. 5A and 5B, illustrates a standard program (PRPGRAM p1) having an extension code 410 created at an Explicit Enhancement Point 404, marked by the keyword/term “enhancement-point,” for example. With respect to the implicit enhancement, while not input at an explicit location as with the explicit enhancement point, the extension code cannot be input anywhere in the on-premise application. Rather, the on-premise application includes limited areas where enhancements may be included (e.g., a beginning or end of a program), referred to herein as “Implicit Enhancement Point” 406 as shown in FIG. 5B. With an implicit enhancement point, there may not be specifically defined import/export parameters, unlike an explicit enhancement point that does include specifically defined import/export parameters. The output of executing Program P1 with the implicit enhancement point is a program with a standard value, a partner extension using a standard value and a program with returned custom value. As described above, on-premise application BADI 408 differs from the implicit and explicit enhancements because it provides flexibility to design the system in a way that it may either have a default code running (provided by the application provider) or the user may overwrite the default code by his add-on/extension. The on-premise application may also include a BADI point/hook 408 as a specific place to include the BADI definition. As described above, moving a functionality of the enhancement provided by the custom extension code from the on-premise application 120 to the cloud platform 112 may not be a direct copy/paste of code, but may require adjustments to have the custom extension code follow the cloud processes. In one or more embodiments, to identify an implicit enhancement, the system may identify a difference between an original application code and the received application code, where the difference is the extension object.

The Web client 104 may comprise one or more individuals (via end user 102) or devices executing program code of a software application for presenting and/or generating user interfaces to allow interaction with the cloud platform 112 and the CE module 114. Presentation of a user interface as described herein may comprise any degree or type of rendering, depending on the type of user interface code generated by the cloud platform 112.

For example, end user 102 may execute the Web client 104 to request and receive a Web page (e.g., in HTML, format) from the cloud platform 112 to access the CE module 114 via HTTP, HTTPS, and/or Web Socket, and may render and present the Error Classification UI 108 or the Enhancement Adjustment UI 110 according to known protocols. The client 104 may also or alternatively present user interfaces by executing a standalone executable file (e.g., an .exe file) or code (e.g., a JAVA applet) within a virtual machine.

The Error Classification UI 108 and the Enhancement Adjustment UI 110 may provide access to two applications to view all errors in the extension code 410 (and a traversal path to the ATC check tool 124) for static error adjustments and to adopt the proposed code enhancement implementations (e.g., mapped cloud elements) suggested by the CE module 114 in a cloud based implementation, respectively.

The Error Classification UI 108 may request and receive data from an Error Classification Engine 126 in a backend of the CE module 114. The Error Classification Engine 126 may be responsible for classifying all the errors via an error classifier 128 in the extension code with respect to severity. For instance, for static errors (like the ones displayed by the static check tool 124), depending on the severity and amount of effort in adjustment of the extension code generated by an effort estimator 130, a High, Medium or a Low Classifier may be assigned to the extension code 410. It is noted that the Error Classification Engine 120 may integrate with an existing static check tool 124 via an API-based integration, or other suitable integration.

An Enhancement Processing Engine 132 may identify the enhancement implementation in the extension code 410 that needs to be adopted to be enabled on the cloud platform 112, as described further below. The Enhancement Processing Engine 132 may include an enhancement reader 144 (including an enhancement code identifier 146), an enhancement implementation adapter 152 (including an enhancement context mapper 150 and an enhancement code generator 154).

The enhancement reader 144 may identify the places in the software that have custom add-ons/extensions. The enhancement implementation adapter 152 may analyze the software objects identified by enhancement reader 144. In this analysis, the context mapper 150 may try to map the point/hook where the custom extension was built (in the on-premise version) to the available point/hook in the cloud software stack (white list). The enhancement code generator 154 may generate the custom add-on/extension code for the hook identified by enhancement context mapper 150. Database 134 may store data used at least by the CE module 114. For example, database 134 may store an enhancement definition template repository 136 and existing DDIC Objects 138. These are Data Dictionary Objects (Tables that are created by software provider and Custom extensions created on these tables by user) which may be used by the CE module 114 during the execution thereof.

Database 134 may comprise any query-responsive data source or sources that are or become known, including but not limited to a structured-query language (SQL) relational database management system. Database 134 may comprise a relational database, a multi-dimensional database, an eXtendable Markup Language (XML) document, or any other data storage system storing structured and/or unstructured data. The data of database 134 may be distributed among several relational databases, dimensional databases, and/or other data sources. Embodiments are not limited to any number or types of data sources.

In some embodiments, the data of database 134 may comprise one or more of conventional tabular data, row-based data, column-based data, and object-based data. Moreover, the data may be indexed and/or selectively replicated in an index to allow fast searching and retrieval thereof. Database 134 may support multi-tenancy to separately support multiple unrelated clients by providing multiple logical database systems which are programmatically isolated from one another.

Database 134 may implement an “in-memory” database, in which a full database is stored in volatile (e.g., non-disk-based) memory (e.g., Random Access Memory). The full database may be persisted in and/or backed up to fixed disks (not shown). Embodiments are not limited to an in-memory implementation. For example, data may be stored in Random Access Memory (e.g., cache memory for storing recently-used data) and one or more fixed disks (e.g., persistent memory for storing their respective portions of the full database).

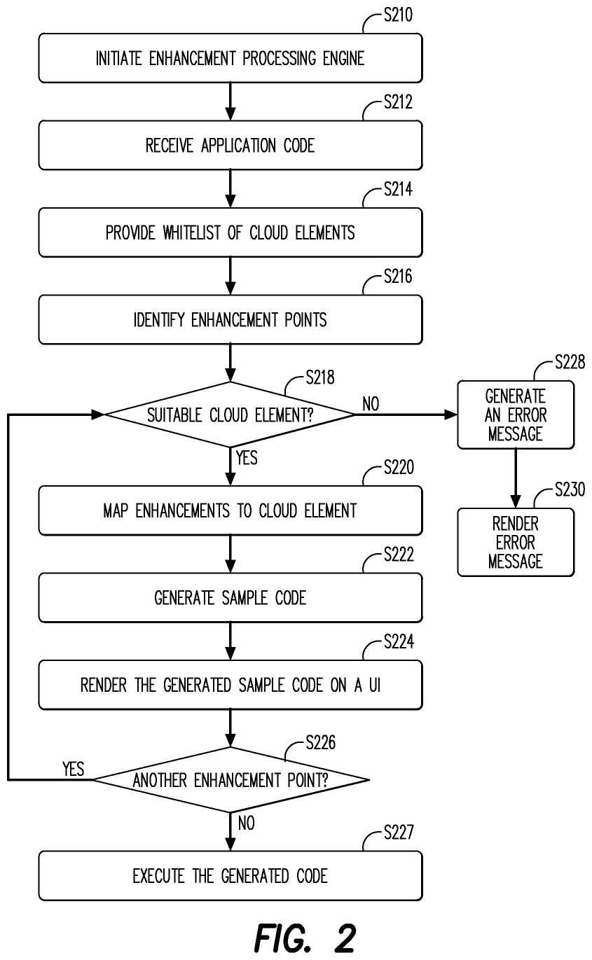

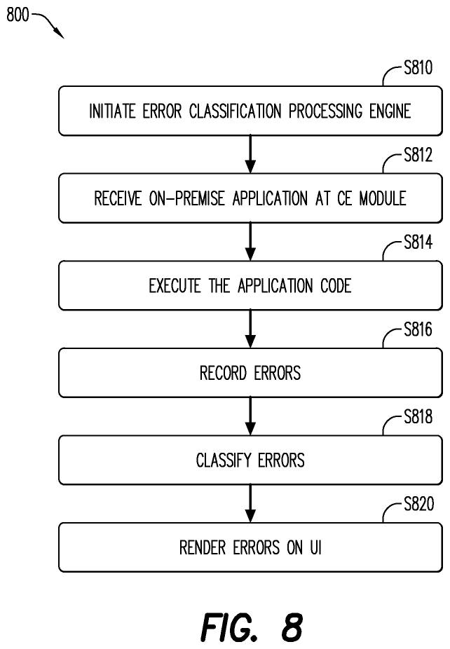

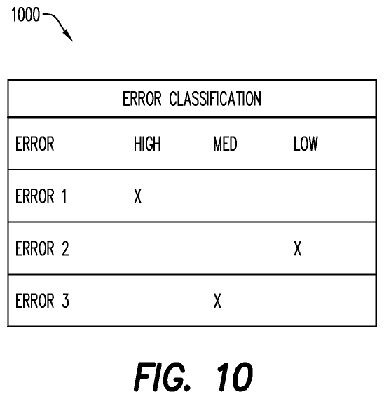

FIG. 2-10 includes a flow diagram of a process 200 (FIG. 2) for facilitating adoption of custom code onto a cloud platform according to some embodiments and a flow diagram of a process 800 (FIG. 8) for classifying the errors in a migrated application. Processes 200/800 may be executed by the software architecture 100 according to some embodiments. In one or more embodiments, the software architecture 100 (e.g., cloud platform 112) may be conditioned to perform the process 200/800, such that a processor 1010 (FIG. 10) of the system 100 is a special purpose element configured to perform operations not performable by a general-purpose computer or device.

All processes mentioned herein may be executed by various hardware elements and/or embodied in processor-executable program code read from one or more of non-transitory computer-readable media, such as a hard drive, a floppy disk, a CD-ROM, a DVD-ROM, a Flash drive, Flash memory, a magnetic tape, and solid state Random Access Memory (RAM) or Read Only Memory (ROM) storage units, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

User interface 1000 (FIG. 10) may be presented on any type of display apparatus (e.g., desktop monitor, smartphone display, tablet display) provided by any type of device (e.g., desktop system, smartphone, tablet computer). One or more embodiments may include a UI renderer which is executed to provide user interface 1000 and may comprise a Web Browser (e.g., as part of the Web client 104), a standalone application, or any other application. Embodiments are not limited to user interface 1000 of FIG. 10.

Prior to the process 200 described below, an on-premise application 120 is received at a cloud platform 112 from an on-premise system 116, via any suitable migration tool/process 121. The user at this point is interested in adopting the custom extension code (e.g., adjusting the custom extension code to make it functional on the cloud platform 112).

Initially, at S210, a user 102 initiates an enhancement processing engine 132. Initiation may be via selection of an enhancement adjustment selector (not shown) on an enhancement adjustment user interface 110.

At S212, application code 122 of the on-premise application 120 is received at a custom code cloud enabler module 114 (“Cloud Enabler Module”).

A whitelist 140 of cloud elements 142 is provided by the Cloud Enabler Module 114 in S214. The cloud elements 142 on the whitelist 140, by virtue of being included on the whitelist 140, have been approved by the cloud platform 112 as being operable with the cloud platform 112. The cloud elements 142 may be at least one of an Application Programming Interface (API) to integrate the on-premise application code with the cloud platform 112 without the need for direct function calls or a cloud-provided source code plug-in to enhance existing application code (e.g., BADI). To facilitate explanation herein, “cloud BADI” will be used as a non-exhaustive example of the cloud-provided source code plug-in to enhance existing application code.

Then, at S216, an enhancement reader 144 of the CE module 114 analyzes the application code 122 to identifies any enhancement points 402 via an enhancement code identifier 146. The enhancement reader 144 may identify the enhancement points object-by-object and may perform the analysis as for the object as the object is identified. As described above, the enhancement point 402 may be one of an explicit enhancement point 404, an implicit enhancement point 406 and an on-premise BADI point 408. In some embodiments, the CE module 114 may first analyze a first object 412 (FIG. 4) to identify an enhancement point 402. As shown in the non-exhaustive example in FIG. 4, the enhancement point 402 is an explicit enhancement point 404.

Next, in S218, the CE Module 114 determines for each identified enhancement point, whether a suitable cloud element 142 exists on the whitelist 140 that may implement the extension code 410. In some embodiments, to determine a suitable cloud element exists, the CE Module 114 selects a first cloud element 142 from the whitelist 140, reads a structure definition (import/export parameters in the case of an explicit enhancement point and BADI definition or lack of import/export parameters in the case of an implicit enhancement point) 414 of the extension code in the enhancement point, and compares it to the structure definition of the selected cloud element 148. As implicit enhancement points do not have parameters and are available either at the beginning or at the end of an object, the user can write any code that he wants to execute before/after the standard code is run. In some instances, the whitelist 140 may include one or more generic elements that may be used as a generic hook (i.e., having no mandatory import/export parameters) for cloud extensions. Hence mapping of an implicit enhancement point to a cloud element on the whitelist may be a mapping of the implicit enhancement point to a cloud element on the whitelist that does not have explicit import/export parameters. For example, if there is an extension implemented using an implicit enhancement point at the beginning of the object (e.g., class, etc.), it may be mapped to the cloud element on the whitelist that does not have explicit parameters defined in the cloud code and is also called in the beginning of the object.

The CE Module 114 may select a given cloud element from the whitelist 140 sequentially (e.g., it may select the first-listed cloud element from the whitelist first for comparison, and if needed, it may then select the second-listed cloud element from the whitelist). In a case the structure definitions match, the cloud element is a suitable cloud element for the extension code 410 at the identified enhancement point 402. It is noted that with respect to the import/export parameters of the structure definition, for there to be a “match”, at least the mandatory parameters are the same (e.g., the optional parameters do not have to match).

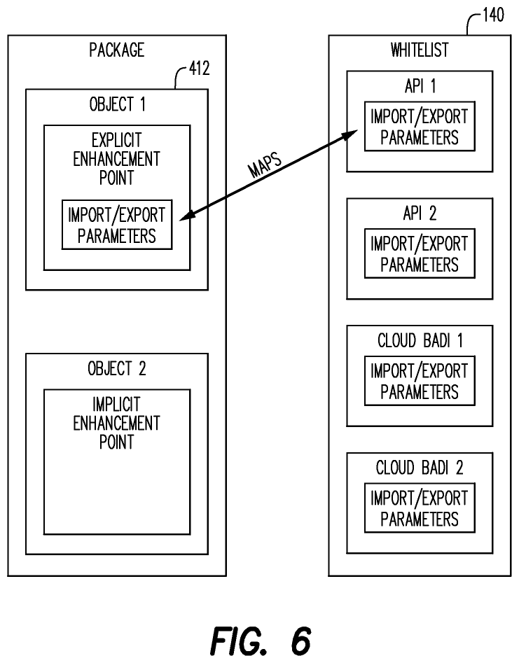

Continuing with the non-exhaustive example in FIG. 6, the CE Module 114 compares the structure definition of the explicit enhancement point 404 of object 1 412 to the structure definition of API 1 in the Whitelist 140.

In a case the structure definitions do not match, or the match is absent, the CE Module 114 selects a second cloud element 142 from the whitelist for comparison. In one or more embodiments, the CE Module 114 may continue to check the cloud elements 142 in the whitelist 140 until at least one of: a suitable cloud element is located, all of the cloud elements in the whitelist are selected, a pre-set amount of time has elapsed, a pre-set amount of cloud elements have been selected, or any other suitable stop point.

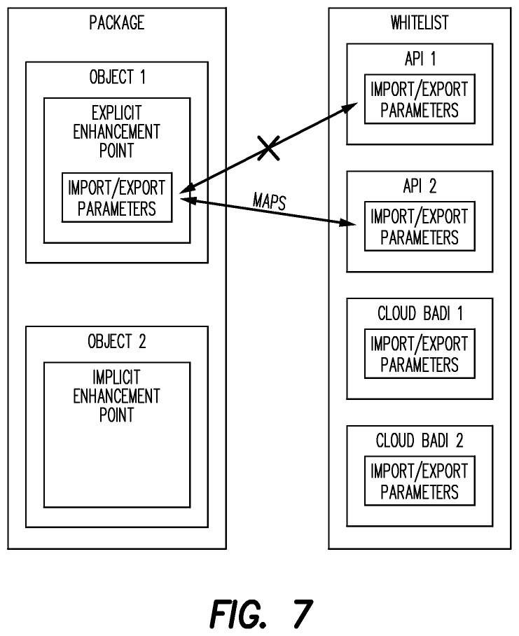

Continuing with the non-exhaustive example in FIG. 7, the CE Module 114 determines API 1 is not a match (a match is absent) for the structure definition of Object 1. The CE Module 114, reads the structure definition 148 of API 2, and determines API 2 is a match.

In a case a stop point has been reached, and a suitable cloud element has not been located, the CE Module 114 may return to S216 to identify another enhancement point 402 in the application code 122. In particular, the CE Module 114 may analyze another object 412 in the same package as the first object to identify a second enhancement point 402. The other object to be analyzed may be a next sequential object in the package, or any other suitable object.

Continuing with the non-exhaustive example, the CE module 114 reached a stop point with respect to explicit enhancement point 404 of Object 1, and may either transmit an error message to the user (e.g., this is a non-usable code on the cloud platform) or provide a suggestion to the user. Then the CE Module 114 identifies Object 2 of the package, as having an implicit enhancement point 406. The process 200 may then continue as above, with S218.

In the case that a suitable cloud element 142 exists, the process 200 continues to S220, and the parameters from the extension code 410 are mapped to the cloud element 142 via an enhancement context mapper 150 of an enhancement implementation adapter 152. As shown in FIG. 6, the structure definition of the explicit enhancement point 404 of Object 1 maps to the structure definition of API 1 in the Whitelist 140.

Then, in S222, the CE Module 114 generates sample code 156 via a code generator 154 of the enhancement implementation adapter 152 to implement the extension code on the cloud platform 112. In one or more embodiments, the generation is based on the context from the custom code written in the extension. The generated sample code 156 may be referred to as a cloud code snippet.

The generated sample code 156 may then be rendered at the user interface 110 in S224. The process 200 then determines if another enhancement point exists in S226. If another enhancement point exists, the process returns to S218. If another enhancement point does not exist, the user may then execute the generated sample code 156 for the extension code 410 as the application code is executed on the cloud platform 112 in S227.

Turning back to S218, and the CE Module 114 determines a suitable cloud element 142 does not exist, the process 200 continues to S232 and an error message 158 is generated. In this case, the structure of the enhancement point may be copied in the error message 158 with an indication that no suitable place/hook is provided for this enhancement point in the cloud application. Then in S234, the error message 158 is rendered at a user interface 110. The CE Module 114 may determine the suitable cloud element 142 does not exist in a case that a stop point is reached and/or no other extension points in the application code 122 exist.

Turning to FIG. 8, as with process 200, prior to the process 800 described below, an on-premise application 120 is received at a cloud platform 112 from an on-premise system 116, via any suitable migration process. The user at this point is interested in an analysis of all the errors with the migration.

Initially, at S810, a user 102 initiates an Error Classification processing engine 126. Initiation may be via selection of an Error Classification selector (not shown) on an Error Classification user interface 108.

As with S212 of process 200, at S812, application code 122 of the on-premise application 120 is received at a custom code cloud enabler module 114 (“Cloud Enabler Module”).

Then in S814, the application code 122 is executed by the CE module 114. Execution may be in a test environment, for example, or other suitable environment. In S816, the CE module 114 records the execution errors 160. Then in S818, the error classifier 128 of the CE module 114 may classify the errors as “static errors” 162 or “context errors” 164. As described above, static errors 162 are those errors that occur when an executable line of code does not follow a pre-defined rule; while context errors 164 are errors that occur at points in the code where a user inserted a user add on. It is noted that identifying the number of context errors/issues may be helpful to provide an overall view of the issues experienced while executing a migrated application. Next, in S820, the errors 160 are rendered on a user interface 1000 (FIG. 10). In one or more embodiments, for the classified static errors 162, the CE module 114 may call an API to integrate a static testing tool 124 (the ATC, as a non-exhaustive example), which may provide data about the static error 162. The data may include, but is not limited to, static errors and their description to correct them. In one or more embodiments, for the classified context errors 164, and prior to S820, the CE Module 114 may further classify these errors in a broad characterization by type of error. This classification may provide for better upskilling of code implementation teams. As a non-exhaustive example, if there were dynamic programming calls made in the on-premise application code 120, which now need to be converted to CDS for implementation on the cloud platform, knowing how many such instances need to be corrected or re-implemented may help determine how many code implementation teams/members needs to be trained with this conversion skill. The CE Module 114 may also, in some embodiments, determine an effort needed to resolve an error via the effort estimator 130. The effort may be calculated based on reference to a pre-defined template that has categories of errors with a bucket size maintained for a given instance. For example, Error1 is mapped to Category 1 and requires effort of medium priority. The effort estimator 130 may classify the errors—both static and context—with a High, Medium, Low Classifier, or any other suitable classification, based on the severity of the error and/or an amount of effort to correct the error as shown in FIG. 10. As a non-exhaustive example, an error of on-premise to Cloud change (changing the syntax of select query) that is expressed three times in the code may have a Classifier of Medium, while an error of on-premise to Cloud change (changing the syntax of update query) that is expressed eight times in the code may have a Classifier of High. The error classification may also be rendered on the UI. In one or more embodiments, the CE module 114 may count the number of errors to determine how many of a particular type exist. The CE Module 114 may also aggregate two or more errors based on a category to facilitate remedial planning purposes.

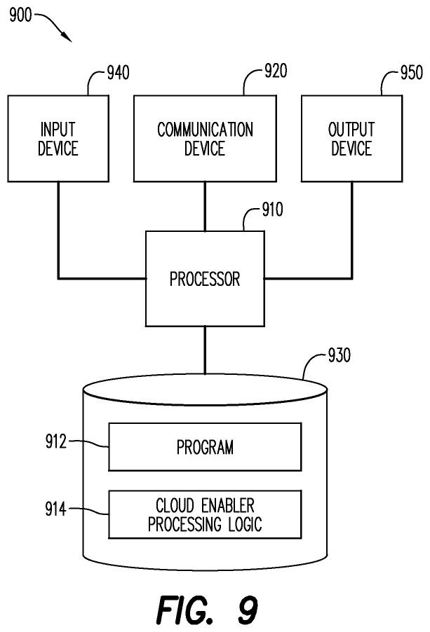

FIG. 9 is a block diagram of apparatus 900 according to some embodiments. Apparatus 800 may comprise a general- or special-purpose computing apparatus and may execute program code to perform any of the functions described herein. Apparatus 900 may comprise an implementation of one or more elements of system 100. Apparatus 900 may include other unshown elements according to some embodiments.

Apparatus 900 includes an CE processor 910 operatively coupled to communication device 920, data storage device 930, one or more input devices 940, one or more output devices 950 and memory 960. Communication device 920 may facilitate communication with external devices. Input device(s) 940 may comprise, for example, a keyboard, a keypad, a mouse or other pointing device, a microphone, knob or a switch, an infra-red (IR) port, a docking station, and/or a touch screen. Input device(s) 940 may be used, for example, to manipulate graphical user interfaces and to input information into apparatus 900. Output device(s) 950 may comprise, for example, a display (e.g., a display screen) a speaker, and/or a printer.

Data storage device/memory 930 may comprise any device, including combinations of magnetic storage devices (e.g., magnetic tape, hard disk drives and flash memory), optical storage devices, Read Only Memory (ROM) devices, Random Access Memory (RAM) etc.

The storage device 930 stores a program 912 and/or CE platform logic 914 for controlling the processor 910. It is noted that program 912 and/or CE logic 914 may also be stored and executed from an application server or from any other environment (e.g., software architecture) that can execute software instructions. The processor 910 performs instructions of the programs 912, 914, and thereby operates in accordance with any of the embodiments described herein, including but not limited to process as 200/800. The executable instructions of the programs 912, 914 represent the executable instructions of the software architecture, including implementation of the methods, modules, subsystems and components and so forth described herein and may also include memory and/or storage modules, etc.

The programs 912, 914 may be stored in a compressed, uncompiled and/or encrypted format. The programs 912, 914 may furthermore include other program elements, such as an operating system, a database management system, and/or device drivers used by the processor 610 to interface with peripheral devices.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of computing devices in communication with one another via any number of other public and/or private networks. Two or more of such computing devices may be located remotely from one another and may communicate with one another via any known manner of network(s) and/or a dedicated connection. Each computing device may comprise any number of hardware and/or software elements suitable to provide the functions described herein as well as any other functions. For example, any computing device used in an implementation of system 100 may include a processor to execute program code such that the computing device operates as described herein.

All systems and processes discussed herein may be embodied in program code stored on one or more computer-readable non-transitory media. Such non-transitory media may include, for example, a fixed disk, a floppy disk, a CD-ROM, a DVD-ROM, a Flash drive, magnetic tape, and solid-state RAM or ROM storage units. Embodiments are therefore not limited to any specific combination of hardware and software.

The embodiments described herein are solely for the purpose of illustration. Those in the art will recognize other embodiments may be practiced with modifications and alterations limited only by the claims.

1. A computer-implemented method comprising:
receiving application code for an on-premise application at a custom code cloud enabler module on a cloud platform, wherein the application code includes at least one package of a plurality of objects;
providing a whitelist of a plurality of cloud elements for the plurality of objects;
identifying, by an enhancement reader executing an object-by-object analysis for one of: i. an enhancement hook in the code for the object, or ii. a difference in application code for the object compared to an original application code, a first enhancement point in a first application object of the plurality of objects, the first enhancement point including a first extension element wherein the first extension element is one of an implicit enhancement point, an explicit enhancement point and an on-premise Business Add-In (BADI) point;
selecting a first cloud element from the whitelist of cloud elements;
determining the selected first cloud element matches a structure definition of the first extension element, wherein the structure definition comprises import/export parameters in a case where the first extension element is the explicit enhancement point or the on-premise BADI point, and comprises a lack of import/export parameters in a case where the first extension element is the implicit enhancement point;
mapping one or more parameters of the first extension element to one or more parameters in the matched first cloud element;
generating a cloud code snippet for the first extension element based on the mapping;
modifying the received application code to include the generated cloud code snippet and
executing the modified application code including the generated cloud code snippet for the first enhancement point as part of cloud code on the cloud platform.

2. The computer-implemented method of claim 1, further comprising, in a case that a match is absent between the first extension element and the plurality of cloud elements:
generating an error message.

3. The computer-implemented method of claim 2, further comprising:
rendering the error message at a user interface.

4. The computer-implemented method of claim 1, wherein the first cloud element is one of an Application Programming Interface (API) and a cloud source code plug-in to enhance existing code.

5. The computer-implemented method of claim 1, further comprising, in a case that the match between the first cloud element and the structure definition of the first extension element is absent:
selecting a second cloud element from the whitelist;
determining the selected second cloud element matches the structure definition of the first extension element;
mapping one or more parameters of the first extension element to one or more parameters in the matched second cloud element;
generating the cloud code snippet for the first extension element based on the mapping; and
executing the generated cloud code snippet for the first enhancement point as part of the cloud code on the cloud platform.

6. The computer-implemented method of claim 1, further comprising:
identifying a second application object of the plurality of objects, wherein the second application object is in a same package as the first application object;
identifying a second enhancement point in the second application object, the second enhancement point including a second extension element;
selecting a second cloud element from the whitelist of cloud elements;
determining the selected second cloud element matches a structure definition of the second extension element;
mapping one or more parameters of the second extension element to one or more parameters in the matched second cloud element;
generating a cloud code snippet for the second extension element based on the mapping; and
executing the generated cloud code snippet for the second enhancement point as part of the cloud code on the cloud platform.

7. (canceled)

8. A computer-implemented method comprising:
receiving application code for an on-premise application at a custom code cloud enabler module on a cloud platform, wherein the application code includes at least one package of a plurality of objects;
receiving selection of an error classification engine;
executing the received application code at the custom code cloud enabler module;
outputting one or more errors based on the execution of the received application code;
assigning the output one or more errors to one of a plurality of categories based on whether the error occurs when an executable line of the application code does not follow a pre-defined rule or whether the error occurs at a point in the application code where a user inserted a user add-on;
proposing a suggestion to resolve the error; and
rendering the assignment of the one or more errors and the proposed suggestion on a user interface display.

9. The computer-implemented method of claim 8, wherein the plurality of categories include a static error category for errors that occur when the executable line of the application code does not follow the pre-defined rule, and an enhancement error category for errors that occur at the point in the application code where the user inserted the user add-on.

10. The computer-implemented method of claim 8, further comprising, in a case of two or more errors:
aggregating the two or more errors based on category.

11. The computer-implemented method of claim 8, further comprising:
determining an effort in resolving each error;
classifying each error with one of a high classifier, a medium classifier and a low classifier based on the determined effort.

12. The computer-implemented method of claim 11, further comprising:
rendering the classification of each error on the user interface.

13. A system comprising:
an on-premise system including at least one on-premise application;
a cloud platform including a custom code cloud enabler module including an enhancement reader;
a cloud enabler computer processor in communication with the custom cloud enabler module; and
a computer memory, coupled to the cloud enabler computer processor and storing processor-executable process steps that, when executed by the cloud enabler computer processor, cause the system to:
receive, at the cloud platform, application code for an on-premise application from the on-premise system, wherein the application code includes at least one package of a plurality of objects;
provide a whitelist of a plurality of cloud elements, and wherein the first cloud element is one of an Application Programming Interface (API) and a cloud source code plug-in to enhance existing code;
identify, via the enhancement reader executing an object-by-object analysis for one of: i. an enhancement hook in the code for the object, or ii. a difference in application code for the object compared to an original application code, a first enhancement point in a first application object of the plurality of objects, the first enhancement point including a first extension element, wherein the first extension element is one of an implicit enhancement point, an explicit enhancement point and an on-premise Business Add-In (BADI) point;
select a first cloud element from the whitelist of cloud elements;
determine the selected first cloud element matches a structure definition of the first extension element, wherein the structure definition comprises import/export parameters in a case where the first extension element is the explicit enhancement point or the on-premise BADI point, and comprises a lack of import/export parameters in a case where the first extension element is the implicit enhancement point;
map one or more parameters of the first extension element to one or more parameters in the matched first cloud element;
generate a cloud code snippet for the first extension element based on the mapping;
modify the received application code to include the generated cloud code snippet and
execute the modified application code including the generated cloud code snippet for the first enhancement point as part of cloud code on the cloud platform.

14. The system of claim 13, further comprising, in a case a match is absent between the first extension element and first cloud element, process steps to cause the system to:
generate an error message.

15. The system of claim 14, further comprising:
a user interface; and
process steps to cause the system to:
render the generated error message on the user interface.

16. The system of claim 13, further comprising, in a case that the match between the first cloud element and the structure definition of the first extension element is absent, process steps to cause the system to cause the system to:
select a second cloud element from the whitelist;
determine the selected second cloud element matches the structure definition of the first extension element;
map one or more parameters of the first extension element to one or more parameters in the matched second cloud element;
generate the cloud code snippet for the first extension element based on the mapping; and
execute the generated cloud code snippet for the first enhancement point as part of the cloud code on the cloud platform.

17. The system of claim 14, further comprising process steps to cause the system to:
identify a second application object of the plurality of objects, wherein the second application object is in a same package as the first application object;
identify a second enhancement point in the second application object, the second enhancement point including a second extension element;
select a second cloud element from the whitelist of cloud elements;
determine the selected second cloud element matches a structure definition of the second extension element;
map one or more parameters of the second extension element to one or more parameters in the matched second cloud element;
generate a cloud code snippet for the second extension elements based on the mapping; and
execute the generated cloud code snippet for the second enhancement point as part of the cloud code on the cloud platform.

18. (canceled)
